(19) United States
(12) Patent Application Publication
(10) Pub. No.: US 2022/0403870 A1
(43) Pub. Date: Dec. 22, 2022

(54) Fastener

(71) Applicant: Roy George Taylor, Wellington (NZ)

(72) Inventor: Roy George Taylor, Wellington (NZ)

(21) Appl. No.: 17/830,267

(22) Filed: Jun. 1, 2022

(30) Foreign Application Priority Data
Jun. 9, 2021 (NZ) 777039

(51) Int. Cl. F16B 35/04; F16B 25/00

(52) U.S. Cl. CPC F16B 35/041; F16B 25/0036

(57) ABSTRACT

It is known to use screws to fasten cladding to the structural timber framing of a building. A problem is that in an earthquake event, movement of the wall can cause the screws to bend and cause non-recoverable damage to the cladding and framing. This may adversely affect the ability of a building to absorb energy sufficient to resist the destructive forces that earthquakes bring to bear. The fasteners address this problem. The fastener has a head 2, a first shaft portion (a fuse) 4 and a second shaft portion (a shank) 5. The fuse extends between the head and the shank and has less resistance to bending than the shank.

### FIELD OF INVENTION

This invention relates to a fastener, for example a screw fastener for use in securing internal or external sheet cladding or other components in a building.

### BACKGROUND

It is known in the context of construction to fasten cladding to the structural timber framing of a building with screws. A problem with this is that during an earthquake movement of the wall can cause the screws to bend and thereby cause non-recoverable damage to the cladding and timber framing surrounding the screw. This may adversely affect the ability of a building to absorb energy sufficient to resist the destructive forces that earthquakes bring to bear. One solution is to more heavily engineer a building to provide it with more or longer bracing walls than may be desirable. However, this tends to adversely increase the costs of construction.

### OBJECT OF THE INVENTION

It is an object of preferred embodiments of the invention to go at least some way towards addressing the above problem. While this applies to preferred embodiments, the object of the invention per se is simply to provide a useful choice. Therefore, any objects or advantages applicable to preferred embodiments should not be taken as a limitation on claims expressed more broadly.

### Definitions

The term “comprising” or “has”, as used in this document in relation to a series of features, means they are present as a minimum combination but does not rule out the option of there being additional features. The same applies to related terms such as “comprises” or “having”.

### SUMMARY OF THE INVENTION

According to one aspect of the invention there is provided a fastener (preferably for installation in timber) comprising—
a head;
a first shaft portion (a fuse); and
and a second shaft portion (a shank);
   formed such that the fuse extends between the head and the shank and has less resistance to bending than the shank.

Optionally the fastener is in the form of a screw in which at least the shank is screw threaded.

Optionally the fastener has a force spreading liner that has an opening large enough to allow the fuse and shaft to pass through, but not large enough to allow the head to pass through.

Optionally the liner is wider than the head.

Optionally the liner comprises a cup that is adapted to receive the head completely within the cup.

Optionally the fastener is used to hold a cladding sheet to wall framing of a building, arranged such that—
the head is located at or adjacent to an outer face of the cladding sheet;
the fuse extends in the cladding sheet; and
the shank extends in the wall framing.

Optionally the fastener is in the form of a screw in which at least the shank is screw threaded.

Optionally the fastener is used to hold a sheet of cladding to wall framing of a building, and is arranged such that—
the head is located at or adjacent to an outer face of the cladding and substantially within or against the liner;
the fuse extends in the cladding; and
the shank extends in the wall framing;
   the arrangement being such that in the event the head is caused to tilt with respect to the cladding it impinges on the liner and not the cladding.

Optionally the liner comprises a plate that is wider than the head.

Optionally the liner comprises a cup and the head is completely within the cup.

Optionally the liner is partially or completely recessed in the cladding.

Optionally the head is inside the exterior surface of the cladding.

Optionally the fuse is thicker immediately adjacent to the head.

Optionally the shank is thicker and is non-threaded immediately adjacent to the fuse.

Optionally the shank is thicker and is threaded immediately adjacent to the fuse.

Optionally the thicker part of the shank immediately adjacent the head is fitted in a pre-formed or self-drilled hole in the framing.

Optionally the cladding is 7 mm to 24 mm thick.

Optionally the cladding comprises plaster board or plywood.

Optionally an exterior face of the cladding has a surface area of at least 2 m².

Optionally 0% to 100% of the length of the fuse is within the cladding.

Optionally 20% to 100% of the length of the shank is within the cladding.

Optionally the fuse is able to withstand a lateral force of 0.5 KN to 5 KN (or 1-4 KN or 2-3 KN).

Optionally the thread stops short of a proximal end of the shank but extends to a distil end of the shank.

Optionally the fuse is substantially narrower than the shank.

Optionally the fuse is 2.5 mm to 10 mm wide and the shank is 5 mm to 10 mm wide (eg as diameter).

Optionally the fastener is installed in framing to secure cladding such that there is space around the fuse such that a portion of the fuse is able to move unobstructed within that space in the event of an earthquake.

Optionally the space around the fuse has been created as a hole drilled through the cladding before installation of the fastener.

Optionally the liner has been rotated to cause a consequential adjustment to bending resistance of the fuse.

### DRAWINGS

Some preferred embodiments of the invention will now be described with reference to the accompanying drawings, of which:

FIG. 1 is a side view of a screw fastener, the liner of which is shown in cross-section;

FIG. 2 is a cross-section view of the fastener when installed;

FIG. 3 is also a cross-section view of the fastener when installed, but after having endured an earthquake;

FIG. 4 is a cross-section of a prior art fastener when installed and after having endured an earthquake;

FIGS. 5A-C are cross-section and plan views of an alternative liner for the fastener of the invention; and

FIGS. 6A-C are cross-section and plan views of a further alternative liner in an alternative embodiment of the invention.

### DETAILED DESCRIPTION

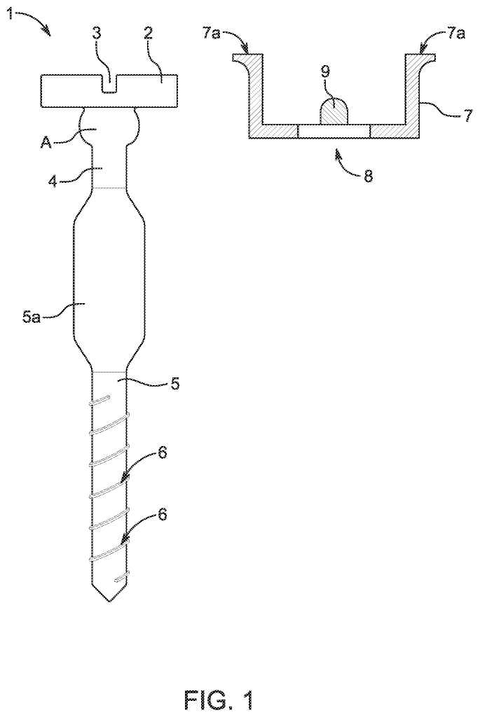

Referring to FIG. 1, the screw fastener 1 has a head 2 with a screwdriver slot 3 or alternative space for use in screwing it into a building component. The head may be integral with a cylindrical first shaft-like portion (or fuse) 4, which in turn extends to and is integral with a cylindrical second shaft-like portion (or shank) 5. The shank 5 may be self-drilling and may also have a helical rib or flute to enable release of drillings, but this is not essential. As shown, the shank 5 has a screw thread 6 but the fuse 4 does not. In this embodiment there is a bulbous part A between the head 2 and the fuse 4 (the bulbous part is wider and has more resistance to bending than the fuse). In some embodiments the bulbous part may be considered to be part of the head or fuse, but not essentially. The fastener also has a cylindrical top-hat-like liner 7, which in this embodiment is generally cup-shaped with a central aperture 8. The aperture is wide enough to enable the fuse 4 and shank 5 to pass through, but not the head 2. As also indicated, the liner has an upstand 9 within its cup shape, but on the outside of the aperture 8. Preferably there are at least two upstands 9 arranged at opposite sides of the aperture 8.

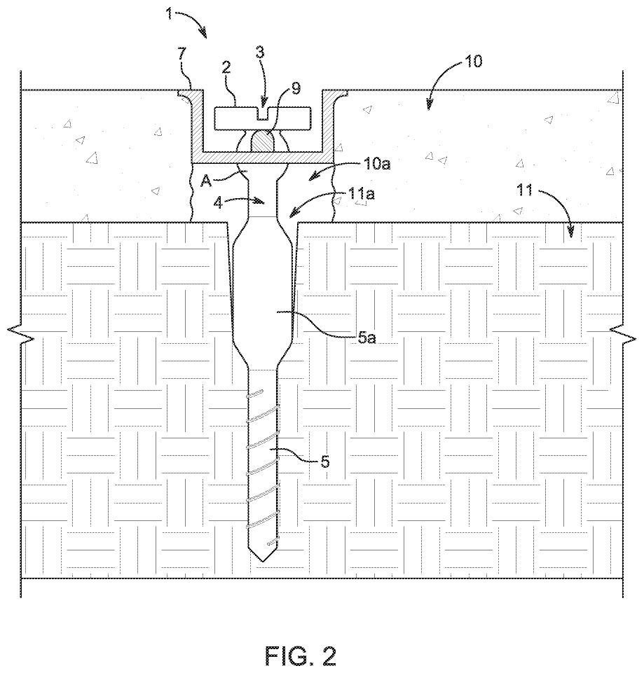

Referring to FIG. 2, the fastener 1 is used to screw-fix wall or ceiling sheet cladding 10 to timber or other framing 11 in a building. The cladding 10 may for example be internal or external, and it may or may not be waterproof or water resistant. The cladding 10 may for example be plywood or may be the same or similar to the well-known internal lining product known as Gib™ plasterboard¹, and the framing may comprise 100 mm by 50 mm, or 100 mm by 75 mm, timber beams. The arrangement is such that the liner 7 is recessed into the cladding 10. The fuse 4 and shank 5 are passed through the liner's central aperture 8 using turning force at the head's slot 3, to drive the shank 5 into the framing 11. In some embodiments a hole 10a may be predrilled through the cladding to facilitate this. Preferably the liner 7 does not rotate as the fuse 4 and shank 5 are screw-driven. When the fastener is installed the fuse 4 may be at least partly in the cladding 10 (it may also extend into the framing), and the thread of the shank 5 may be more or less wholly within the framing 11. In preferred embodiments a wider unthreaded portion 5a of the shank is within the framing 11 immediately adjacent to the cladding. To facilitate this, a shallow-depth pre-drilled hole 11a may be formed in the framing 11 to accommodate the wider portion 5a. Further, the bottom of the head 2 is held against the top of the upstand 9 inside the liner 7 to securely hold the cladding against the framing. In practice the liner may be covered, after installation, with an aesthetic skim of filler.

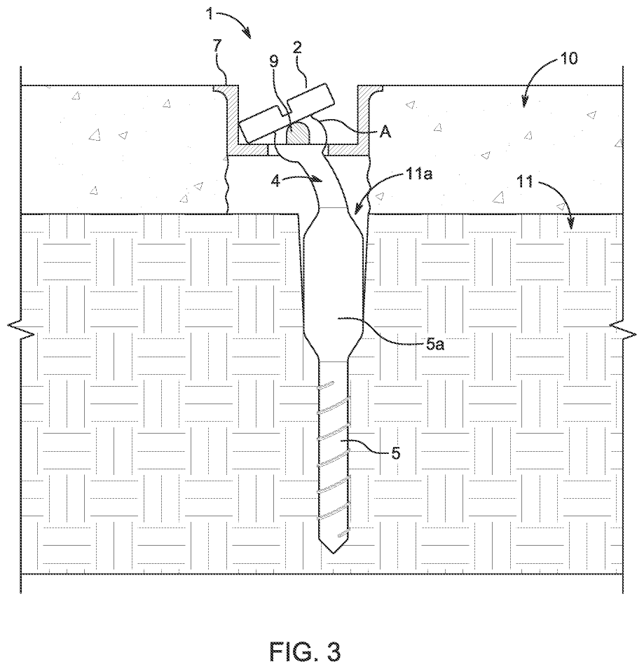

Referring to FIG. 3, in the event of a significant earthquake the wall or ceiling that has the cladding and framing is subject to movement. This places a force on the fastener 1 to the extent that the fuse 4 bends with corresponding tipping or other movement of the head 2. However as the head 2 is within the liner 7, the force acting on the head is spread by the liner, e.g. as the head tips or rotates or otherwise presses down on the upstand 9 or, in extreme cases, against the internal side or bottom of the liner. Because the fuse 4 is thinner than the bulbous part A, in some embodiments only the fuse yields. This protects the cladding 10 from the sort of destructive ‘crushing’ or ‘crumbling’ around the head that would occur if the liner was not present. It serves to keep the cladding 10 tight against the framing 11 to help brace the wall or ceiling that it is part of, and therefore to help prevent or reduce damage from the earthquake around the liner 7 and to the building as a whole, and from subsequent earthquakes. Further, it serves to prevent or reduce damage to the wood fibres of the framing 11 around the shank. As a consequence the building is less likely to need repair to the cladding after the earthquake.

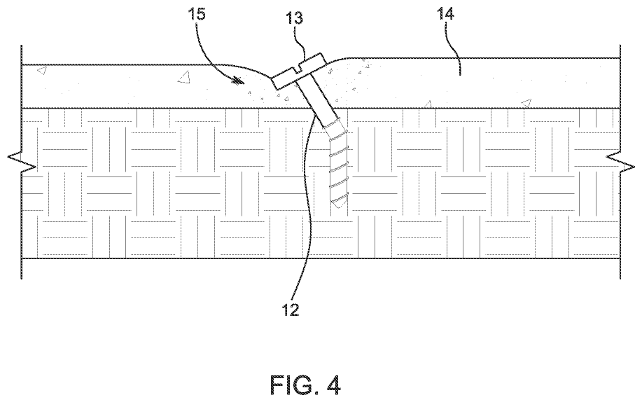

By way of example and for contrast, FIG. 4 illustrates how with standard prior art screw fasteners 12, movement of the head 13 in an earthquake breaks up the cladding 14 around the screw, especially in the vicinity of the head. This can leave a loose or soft zone 15 so that the cladding is not sufficiently held against lateral movement of the framing to give adequate energy absorption resistance to an earthquake. While not shown in the drawing the timber framing may also be damaged around the shank to weaken the connection between the fastener and framing.

Referring again to FIGS. 1 and 2, in other embodiments of the invention the liner's upstand 9 may be omitted so that when the fastener is installed the head 2 presses against the bottom of the liner. However it is preferred to include the upstand 9, or some alternative feature such as a ledge, to hold the head 2 up off the base of the liner to better provide what is in effect a ‘pin joint’.

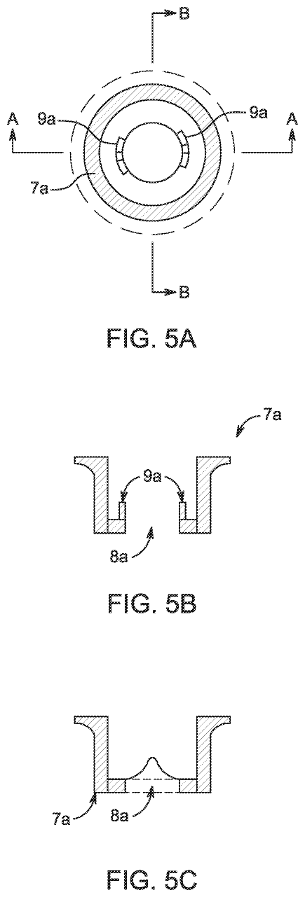

FIGS. 5A-C illustrate an optional alternative liner 7a which also has a central aperture 8a and upstand 9a. The upstand may be in two parts, each at an opposite side of the aperture 8a.

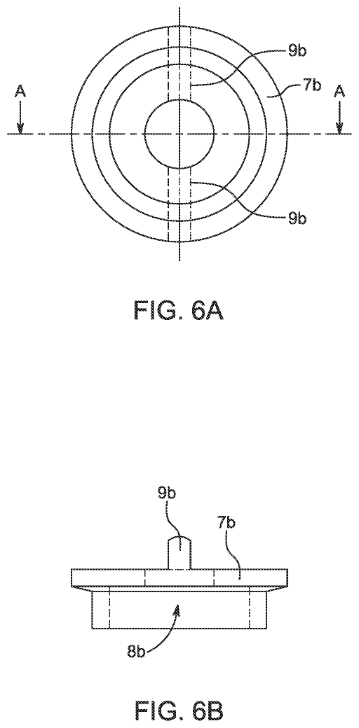

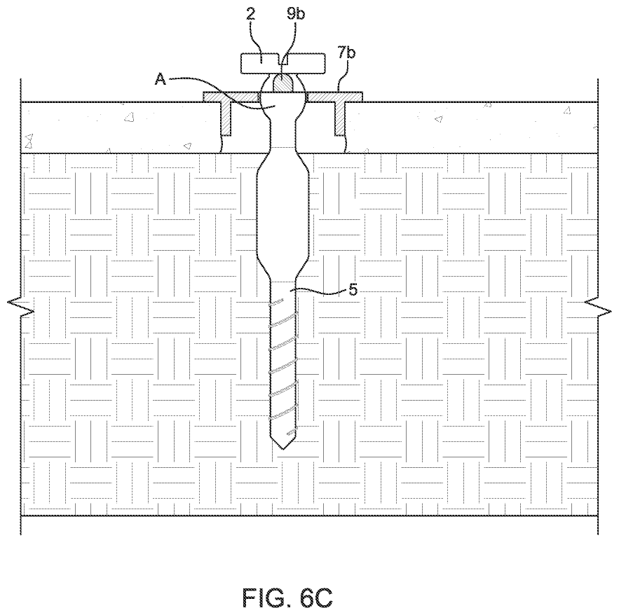

Referring to FIGS. 6A-C, in alternative embodiments of the invention the liner 7 may be substituted by a plate like liner 7b that has a central aperture 8b and an upstand 9b that is also in two parts. As illustrated in FIG. 6c, the fastener head 2 is not cupped by the liner 7b, but rather sits on top of it. In the event of an earthquake the fuse 4 and head 2 can bend or tilt in more or less the same way as for FIG. 3. In this regard the bulbous portion A just below the head may press against the plate-like portion of the liner 7b to spread the force and protect the cladding from the sort of deformation or damage described for FIG. 4. While plywood and plasterboard have been referred to for the cladding above, the invention is not limited to these. In this regard suitable other sheet-like materials may be used for the cladding.

In some embodiments of the invention the fastener 1 may be made or used with any single or any combination of the following parameters—

| Feature | Value |
|---|---|
| Fastener 1 | Made from one or more of high tensile steel or other |
| | suitable metallic material. |
| Fastener 1 | Length of fastener overall of 40 mm to 90 mm. |
| Fuse 4 | Able to withstand a lateral force of 0.5-5 KN, or 1-4 KN, |
| | or 2-3 KN. |
| Fuse 4 | Width (eg diameter) of fuse (if of uniform thickness), or |
| | of narrowest part of the fuse (if not of uniform thickness), |
| | is 2.5-10 mm, or 4-8 mm, or 5-7 mm. |
| Fuse 4 | Length of fuse is 6 mm to 15 mm, or 8 mm to 13 mm, or 9 |
| | mm to 12 mm, or 10 mm to 11 mm. |
| Fuse 4 | Proportion of the length of the fuse that is within the |
| | cladding 0% to 100%, or preferably 40% to 50%. |
| Shank 5 | Width (eg diameter) of shank (excluding pointed tip) is 5- |
| | 10 mm, or 6-9 mm, or 7-8 mm. |
| Shank 5 | Length of shank is 10-60 mm, or 20-50 mm, or 30-40 mm |
| Shank 5 | Proportion of the length of the shank that is within the |
| | framing (11) - 20% to 100%. |
| Cladding 10 | Thickness of 7-24 mm, or 10-21 mm, or 13-18 mm, or |
| | 15-16 mm. |
| Cladding 10 | Surface area of exterior face of sheet of at least 2 m². |

While preferred embodiments have been described above for one fastener 1, it will be appreciated that in practice multiple of these would be used spaced out for each sheet of cladding.

In some embodiments of the invention the effective lateral seismic capacity of the fastener 1 may be adjusted on-site without needing to modify it. For this, the liner 7 may simply be rotated on installation by varying degrees, up to a maximum of 90 degrees. This can alter the moment developed by the head 2 when under load. In some embodiments small fins that are aligned to the axis of the fastener may be used on the outside of the liner 7. They serve to prevent undesired rotation of the liner, with unintentional alteration to the capacity “setting” of the liner 7.

Preferably the floor of the liner 7 is capacity designed to yield and shed load before the fastener pulls out of the framing 11. By way of example, the amount of effective axial shortening of the fastener may be 1.4 mm when it reaches 6 mm lateral travel.

Referring to FIG. 1, the flange 7a at the top of the liner 7 may be arranged to engage with the cladding 10 and ‘deform into it’ so as to recess the top of the liner just below the outer surface of the cladding for an aesthetic finish. Further, the liner 7 may be drawn into the cladding by screw-tensioning the fastener or by impact with a machine component or hand tool. This may be achieved using a purpose designed light impact power tool that is tuned to set the top of the liner just below the exterior surface of the cladding to avoid excessive damage to the cladding. To facilitate this, the flange 7a of the liner 7 may be thin at its outside edge to minimise depression, and at the same time curved downwards towards the edge of the corresponding hole in the cladding to depress the cladding more where it is more easily depressed. For embodiments of the invention where the cladding is not plasterboard, for example where it is plywood sheet, the underside of the flange 7a may have radial cutting teeth so as to self-drill and recess the liner on installation.

The liner 7 may serve to minimise “popping” of the cladding, i.e. where a prior art fastener (as per FIG. 4) may force a small section of cladding out, disfiguring it. The liner can serve to reduce this because movement of the head 2 is cushioned by the liner's flange 7a, and by flexing of the base of the liner when pulled on. Further, outward movement of the head 2 is initially confined by flexible sealant in the liner. If significant movement occurs it may simply be a matter of reshaping or re-doing the flexible sealant within the outer cavity of the recess.

Preferably a hole is pre-drilled in the framing 11 just below the liner 7 (optionally 16 mm-20 mm diameter), this being deep enough to provide for free lateral movement of the fuse 4 by up to 8 mm without engaging the timber at the side of the hole as the cladding 10 slides relative to the framing 11. However the hole is not formed so deep as to reduce the effectiveness of the enlarged section 5a bearing laterally on the framing (see FIGS. 1 and 2) immediately below the fuse 4. In some embodiments the hole may be other than pre-drilled; rather being created by providing the shank with self-drilling features.

In a further embodiment of the invention the design may be such that if the fastener is unable to yield, for example because part of the fastener bears against the hole in the framing and so its effective capacity increases beyond that designed for, then another part of the system may yield to compensate for this. For example hold-down brackets may be used at the ends of the sheets of the cladding and these may ‘flex or otherwise “give’, in place of the fuse.

In some embodiments of the fastener 1 the fuse may be further ‘necked’ (i.e. with a reduced width) to reduce its load capacity to a desired level, optionally near the head of the screw. Alternatively, the fuse may be enlarged slightly near the shank 5 to match a reducing moment profile over the length of the fastener, and so spread ‘plastic strain’ over a greater distance. This can serve to produce better plastic action and reduce the risk of low cycle fatigue. To elaborate, if the fuse is narrow-necked near the fastener's head, the moment capacity of the fuse will be correspondingly reduced. This in turn can reduce an undesired unpredictable moment near the fastener's head due to restraint of the head. It does not apply in the case of the ledges 9 because in that instance the joint between the head 2 and liner 7 is effectively, at least nearly, a theoretical ‘pin’. Conversely, a progressive enlargement of the diameter of the fuse results in a near constant flexural strain along the fuse at the critical point near the shank 5. The above distribution of strain is preferable as the fuse is better able to complete multiple strain cycles before rupturing.

In some embodiments, the upper opening into the liner 7 may be left without a skim of plaster so as to not restrict rotation of the head 2 which may otherwise lead to a greater risk of damage in an earthquake. Instead, an alternative material such as a flexible ‘paint-over’ sealant may be used, which allows for rotation of the head 2 more freely than a skim of plaster. Optionally a small removable plug may be inserted in the opening of the liner, e.g. in the screw driver slot 3 (see FIG. 1) to facilitate easy future driving of the screw if needed.

Optionally, in preferred embodiments of the fastener 1, rotation of the head 2 causes a measurable outward movement of the face of the wall. The degree of movement may provide information to an engineer as to the extent of damage and/or movement in an earthquake.

In some embodiments of the invention the fastener may be produced to give heavy duty performance, for example to attach metal to wood. In this case the fastener may be made to resist approximately 3.4 KN of lateral load. It may incorporate all the same features including the fuse, an enlarged section immediately beyond the fuse (e.g. the part 5a of FIG. 1), and the holes for the liner enlarged to approximately 20 mm diameter.

In other embodiments of the invention the fastener 1 may be used, with or without the liner 7, for fixing joining plates on portal frames, or for joining timber beams and columns with plates in a multi-storey build, optionally possibly in conjunction with a pre-stressing system.

Although in preferred embodiments of the invention the fastener 1 is screw threaded, for example as a coach screw or bolt, in other embodiments it may have no thread. In that case the fastener may be in the form of a nail that is applied in a predrilled hole in the framing.

While some preferred embodiments of the invention have been described by way of example it should be appreciated that modifications and improvements can occur without departing from the scope of the following claims.

In terms of disclosure, this document hereby discloses each item, feature or step mentioned herein in combination with one or more of any of the other item, feature or step disclosed herein, in each case regardless of whether such combination is claimed.

I claim:

1. A fastener comprising—
a head;
a first shaft portion (a fuse); and
and a second shaft portion (a shank);
formed such that the fuse extends between the head and the shank and has less resistance to bending than the shank.

2. A fastener according to claim 1, in the form of a screw in which at least a portion of the shank is screw threaded.

3. A fastener according to claim 2, comprising a force spreading liner that has an opening large enough to allow the fuse and shaft to pass through, but not large enough to allow the head to pass through.

4. A fastener according to claim 3, wherein the liner is wider than the head.

5. A fastener according to claim 4, wherein the liner comprises a cup that is adapted to receive the head completely within the cup.

6. A fastener according to claim 1, when used to hold a cladding sheet to wall framing of a building, arranged such that—
the head is located at or adjacent to an outer face of the cladding sheet;
the fuse extends in the cladding sheet; and
the shank extends in the wall framing.

7. A fastener according to claim 6, in the form of a screw in which at least the shank is screw threaded.

8. A fastener according to claim 3, when used to hold a sheet of cladding to wall framing of a building, arranged such that—
the head is located at or adjacent to an outer face of the cladding and substantially within or against the liner;
the fuse extends in the cladding; and
the shank extends in the wall framing;
the arrangement being such that in the event the head is caused to tilt with respect to the cladding it impinges on the liner and not the cladding.

9. A fastener according to claim 8, wherein the liner comprises a plate that is wider than the head.

10. A fastener according to claim 8, wherein the liner comprises a cup and the head is completely within the cup.

11. A fastener according to claim 8, wherein the liner is partially or completely recessed in the cladding.

12. A fastener according to claim 8, wherein the head is inside the exterior surface of the cladding.

13. A fastener according to claim 7, wherein the fuse is thickest immediately adjacent to the head.

14. A fastener according to claim 1, wherein the shank is at its thickest and is non-threaded immediately adjacent to the fuse.

15. A fastener according to claim 1, wherein the shank is at its thickest and is threaded immediately adjacent to the fuse.

16. A fastener according to claim 8, wherein the cladding comprises plaster board or plywood.

17. A fastener according to claim 1, when installed in framing to secure cladding such that there is space around the fuse such that a portion of the fuse is able to move unobstructed within that space in the event of an earthquake.

18. A fastener according to claim 5, wherein:
the fastener is holding cladding sheet to wall framing of a building;
the head is completely within the cup;
the fuse is thicker immediately adjacent to the head than it is immediately adjacent to the shank;
the head is located at or adjacent to an outer face of the cladding sheet;
the fuse extends in the cladding sheet;
the shank extends in the wall framing;
the liner is recessed in the cladding; and
Zo the head is inside the exterior surface of the cladding.

19. A fastener according to claim 18, wherein the cladding sheet is a sheet of plywood.

20. A fastener according to claim 4, wherein:
the fastener is holding cladding sheet to wall framing of a building;
the head is on the outside of the liner;
the fuse is thicker immediately adjacent to the head than it is immediately adjacent to the shank;
the head is located at or adjacent to an outer face of the cladding sheet;
the fuse extends in the cladding sheet;
the shank extends in the wall framing; and
the liner is engaged in the cladding.

21. A fastener according to claim 20, wherein the cladding sheet comprises a sheet of plywood.

22. A fastener according to claim 6, wherein the fuse is substantially narrower than the shank.

23. A fastener according to claim 1, wherein the fuse is substantially narrower than the shank.

24. A fastener according to claim 6, arranged such that rotation of the liner will cause a consequential adjustment to bending resistance of the fuse.
